(19) United States
(12) Patent Application Publication
(10) Pub. No.: US 2017/0331694 A1
(43) Pub. Date: Nov. 16, 2017

(54) OPTIMIZING A NETWORK TOPOLOGY TO SATISFY PREDICTED GROWTH

(71) Applicant: ARIA NETWORKS LIMITED, Bath (GB)

(72) Inventors: John CRICKETT, Chippenham Wiltshire (GB); Jay PERRETT, Chippenham Wiltshire (GB); Andrea CELLETTI, Chippenham Wiltshire (GB)

(21) Appl. No.: 15/531,256

(22) PCT Filed: Nov. 27, 2015
(86) PCT No.: PCT/GB2015/053643

§ 371 Date: May 26, 2017

(30) Foreign Application Priority Data
Nov. 28, 2014 (GB) 1421172.6

(51) Int. Cl. H04L 12/24

(52) U.S. Cl. CPC H04L 41/0896; H04L 41/12; H04L 41/04; H04L 41/0836

(57) ABSTRACT

Methods and systems for determining a network topology for each of a plurality of demand scenarios. The method includes identifying, using an iterative process that involves generating and evolving a set of candidate network topologies, a network topology for the highest demand scenario. A network topology is then identified for the next highest demand scenario using the same iterative process, but this time the set of candidate network topologies is seeded to include the identified network topology for the highest demand scenario. This process repeats for each other demand scenario so that the set of candidate network topologies for a particular demand scenario is seeded with the identified network topology for the next highest demand scenario.

### BACKGROUND

A network is often designed to meet the current demands placed on the network (e.g. the amount of traffic being sent between nodes of the network). However, over time network demands (e.g. traffic) typically grow or increase. This often requires changes to the network (e.g. topology) to be able to accommodate the growth.

While it is possible, using various techniques, to predict the demand growth, it is currently an intractable task, particularly for large networks, to determine how to optimally change the network topology to accommodate the increased demand. This is particularly true when the growth is predicted for a plurality of different periods in the future. As a result network operators/owners typically overbuild their networks to ensure it can accommodate predicted demand growth. In particular, they tend to build the network for the capacity expected in six, twelve or eighteen months' time and run the network at 50% in the meantime. This is extremely wasteful and costly.

Accordingly there is a desire to be able to determine the optimum network topology for predicted growth for a plurality of different time periods so a network's topology can be adjusted in the most efficient manner to meet the predicted growth.

The embodiments described below are not limited to implementations which solve any or all of the disadvantages of known network optimization systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are methods and systems for determining a network topology for each of a plurality of demand scenarios. The method includes identifying, using an iterative process that involves generating and evolving a set of candidate network topologies, a network topology for the highest demand scenario. A network topology is then identified for the next highest demand scenario using the same iterative process, but this time the set of candidate network topologies is seeded to include the identified network topology for the highest demand scenario. This process repeats for each other demand scenario so that the set of candidate network topologies for a particular demand scenario is seeded with the identified network topology for the next highest demand scenario.

A first aspect provides a system to generate a network from a plurality of demand scenarios, each demand scenario identifying a demand for each of a plurality of services to be run over the network, each demand indicating an amount of data to be transmitted from a start node to an end node, the system comprising: one or more computer-based modules configured to: (a) identify a demand scenario of the plurality of demand scenarios with the highest demands as a first demand scenario; (b) identify, using an iterative process, a topology satisfying the first demand scenario, the iterative process comprising generating and evolving a set of candidate network topologies; (c) identify the first demand scenario as a second demand scenario; (d) identify a demand scenario of the plurality of demand scenarios with the next highest demands compared to the second demand scenario as the first demand scenario; (e) identify a topology satisfying the first demand scenario using the iterative process, wherein the set of candidate network topologies for the first demand scenario comprises the identified network topology for the second demand scenario; and (f) repeat (c) to (e) until a topology for each demand scenario has been identified and output the identified topology for each demand scenario; and means for generating a network having one of the output topologies.

A second aspect provides a system to determine a topology of a network for each of a plurality of demand scenarios, each demand scenario identifying a demand for each of a plurality of services to be run over the network, each demand indicating an amount of data to be transmitted from a start node to an end node, the system comprising: one or more computer-based modules configured to: (a) identify a demand scenario of the plurality of demand scenarios with the highest demands as a first demand scenario; (b) identify, using an iterative process, a topology satisfying the first demand scenario, the iterative process comprising generating and evolving a set of candidate network topologies; (c) identify the first demand scenario as a second demand scenario; (d) identify a demand scenario of the plurality of demand scenarios with the next highest demands compared to the second demand scenario as the first demand scenario; (e) identify a topology satisfying the first demand scenario using the iterative process, wherein the set of candidate network topologies for the first demand scenario comprises the identified network topology for the second demand scenario; and (f) repeat (c) to (e) until a topology for each demand scenario has been identified and output the identified topology for each demand scenario.

A third aspect provides a method to generate a network from each of a plurality of demand scenarios, each demand scenario identifying a demand for each of a plurality of services to be run over the network, each demand indicating an amount of data to be transmitted from a start node to an end node, the method comprising: (a) identifying a demand scenario of the plurality of demand scenarios having the highest demands as a first demand scenario; (b) identifying, using an iterative process, a topology satisfying the first demand scenario, the iterative process comprising generating and evolving a set of candidate network topologies; (c) identifying the first demand scenario as a second demand scenario; (d) identifying a demand scenario of the plurality of demand scenarios with the next highest demands compared to the second demand scenario as the first demand scenario; (e) identifying a topology satisfying the first demand scenario using the iterative process, wherein the set of candidate network topologies for the first demand scenario comprises the identified network topology for the second demand scenario; (f) repeating (c) to (e) until a topology for each demand scenario has been identified and outputting the identified topology for each demand scenario; and (g) generating a network having one of the output topologies.

A fourth aspect provides a computer-implemented method to determine a topology of a network for each of a plurality of demand scenarios, each demand scenario identifying a demand for each of a plurality of services to be run over the network, each demand indicating an amount of data to be transmitted from a start node to an end node, the method comprising: (a) identifying, using a computing-based device, a demand scenario of the plurality of demand scenarios having the highest demands as a first demand scenario; (b) identifying, using an iterative process run on a computing-based device, a topology satisfying the first demand scenario, the iterative process comprising generating and evolving a set of candidate network topologies; (c) identifying using the computing-based device, the first demand scenario as a second demand scenario; (d) identifying, using the computing-based device, a demand scenario of the plurality of demand scenarios a next highest demands compared to the second demand scenario as the first demand scenario; (e) identifying, using a computing-based device, a topology satisfying the first demand scenario using the iterative process, wherein the set of candidate network topologies for the first demand scenario comprises the identified network topology for the second demand scenario; and (f) repeating (c) to (e) until a topology for each demand scenario has been identified and outputting the identified topology for each demand scenario.

A fifth aspect provides a computer readable storage medium having encoded thereon computer readable program code which when run by a computer causes the computer to perform the method of the fourth aspect.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of example network topologies to satisfy increasing demands;

FIG. 2 is a schematic diagram of an example demand matrix representing multiple demand/growth scenarios;

FIG. 3 is a block diagram of an example method for identifying an optimum network topology for each of a plurality of demand/growth scenarios;

FIG. 4 is a block diagram of an example system for identifying an optimum network topology for a demand/growth scenario;

FIG. 5 is a flow diagram of an example method for identifying an optimum network topology for a demand/growth scenario using the system of FIG. 4;

FIG. 6 is a schematic diagram illustrating generation of a set of candidate network topologies;

FIG. 7 is a schematic diagram illustrating assigning capacity values to links of a candidate network topology;

FIG. 8 is a schematic diagram of an example set of constraints;

FIG. 9 is a flow diagram of an example method of evaluating a candidate network topology;

FIG. 10 is a flow diagram of an example method for evolving the set of candidate network topologies;

FIG. 11 is a schematic diagram illustrating a method of generating child candidate network topologies through mating;

FIG. 12 is a schematic diagram illustrating a method of generating child candidate network topologies through mutation;

FIG. 13 is a chart illustrating an example stop condition; and

FIG. 14 is an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein are methods and systems for identifying an optimum network topology for each of a plurality of demand/growth scenarios.

The term “network” is used herein to mean any interconnection of elements for the transfer of data or information. A network may comprise a plurality of physical objects, such as a network of IP (Internet Protocol) routers, a telephone communications system, a utility distribution system or a network of blood vessels. Alternatively, a network may comprise a plurality of abstract objects, such as a data flow or social interactions. The topology of a network defines the specific interconnections or links between the objects of the network.

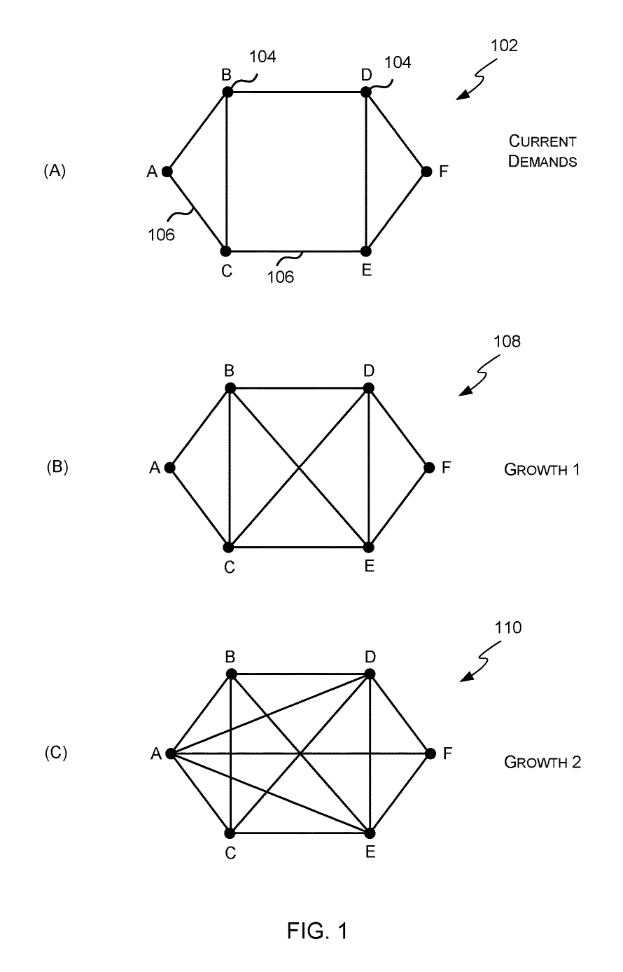

Reference is made to FIG. 1 which illustrates example network topologies. In particular, FIG. 1A illustrates a first network topology 102. It can be seen that the network topology 102 comprises a number of nodes 104 and links 106 that connect the nodes. Each node 104 represents a terminal point or intersection point of the network. A node may be, for example, a topology element such as a location in a network; a system; a physical element such as a router, switch terminal, hub, branch, intersection or the like; or a virtual element such as a channel.

Each link 106 provides a connection between two nodes. A link may be, for example, a physical element such as a cable, pipe or road; an abstract element such as a network link; or a virtual element such as a channel or frequency of a link or cable. Each link is typically associated with a capacity (e.g. bandwidth) that defines the amount of data/information that can be transferred between the two nodes connected via the link.

A network topology is typically designed to meet current demands (e.g. the amount of traffic to be sent between nodes of the network). However, as demands increase the original network topology may no longer be able to support the demands. Accordingly, it is desirable to be able to determine how to modify the network topology to meet increased demands. Modifying the network topology may involve altering the capacity (e.g. increasing or decreasing the bandwidth) on one or more links of the network topology and/or adding or removing one or more links to/from the network topology. In particular, in some cases the network may be more efficient if a link is removed and the traffic is re-routed over other under-utilized links.

For example, if the first network topology 102 in FIG. 1A is designed to meet the current demands, when the demands grow or increase then one or more links may be added to the first network topology 102 to produce a second network topology 108 capable of supporting the increased demands. In the example of FIG. 1, the links between nodes B and E; and C and D have been added to the first network topology 102 to produce the second network topology 108.

If the demands further increase then one or more additional links may be added to the second network topology 108 to produce a third network topology 110 capable of supporting the further increased demands. In the example of FIG. 1 the links between nodes A and D; A and F; and, A and E have be added to the second network topology 108 to produce the third network topology 110.

Generally network users/operators want to pre-empt reaching a state where the network can no longer support current demands so they generate predictions for the growth (demands). The network users/operators then want to know what changes to make to the network topology in the near and/or far future to be able to support the predicted future demand. Network users/operators generally prefer changes that minimize capital expenditures (CAPEX) and operating expenditures (OPEX).

The predicted demands or growth for a particular time period may be referred to as a demand/growth scenario. A demand/growth scenario specifies a set of services for a network and the demands or requirements thereof for the particular time period.

A demand/growth scenario is typically represented by a demand matrix which lists the demand or requirement of each service that is run over the network in the scenario. A service represents traffic/information/data that is sent from one node (i.e. the start node or source node) in a network to another (i.e. the end node or destination node). The demand or requirement of a service is the amount of traffic/data/information sent from the start node to the end node. The demand or requirement may be represented by a bandwidth or capacity value. Where the demand is a predicted demand for a future time period, the predicted demand may be represented by a bandwidth or capacity value (e.g. 5 Gbps) or as a percentage of the demand in a previous time period (e.g. 10% increase over the demand for the previous time period). A time period may be any increment in time such as, but not limited to, days, months, years, etc. A time period may also be referred to herein as an “epoch” and the two terms will be used interchangeably herein.

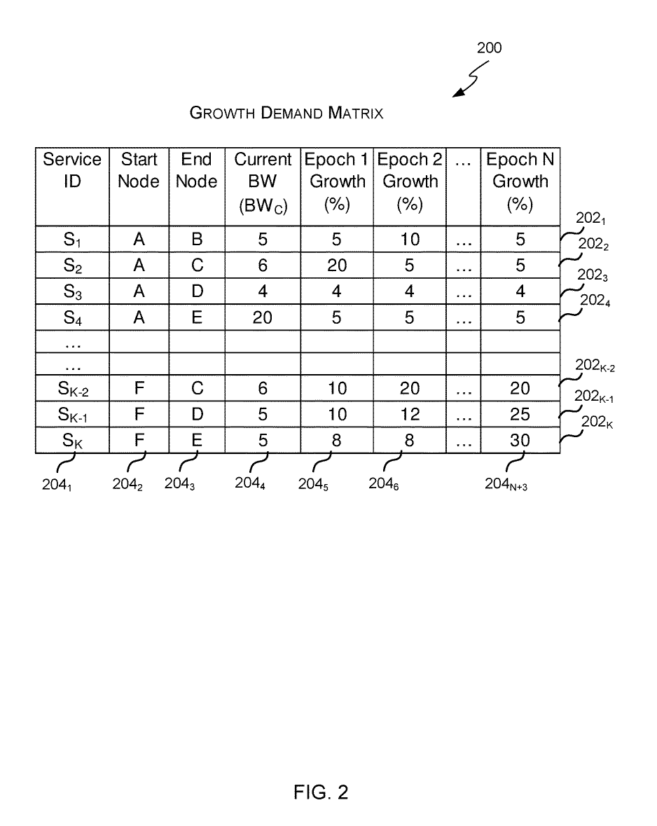

An example demand matrix 200 representing multiple demand/growth scenarios is illustrated in FIG. 2. The demand matrix 200 of FIG. 2 comprises a number of rows 202₁-202_{K} and columns 204₁-204_{N+3}.

Each row 202₁-202_{K} corresponds to a service that runs over the network. Accordingly, where there are K services there are K rows in the demand matrix 200. In some cases each possible combination of start and end nodes in the network is represented by a single service. For example, where a network has four possible start/end nodes (A, B, C and D) there are 4*3=12 possible combinations of start and end nodes thus the demand matrix would have twelve rows. In other cases there may be more than one service with the same set of start and end nodes. The services sharing the same start and end nodes may have different requirements/demand, different quality of service (QoS) levels or different routing rules.

Each column 204₁-204_{N+3} provides information on the corresponding service. In the demand matrix 200 of FIG. 2, the first column 204₁ is used for the service identifier (e.g. S₁) which uniquely identifies the service. The second column 204₂ is used to identify the start node of the service, and the third column 204₃ is used to identify the end node of the service. In some cases nodes may be assigned a unique identifier which is used to identify the start and end nodes in the demand matrix 200. In the example shown in FIG. 2 each node is assigned a letter, but it will be evident to a person of skill in the art that this is an example only and other forms of unique identifiers may be used.

The remaining columns 204₄-204_{N+3} are each used to describe a particular demand/growth scenario. In particular, each of these columns identifies the demand or requirement for the service (e.g. the amount of traffic that is sent from the specified start node to the specified end node) for a particular time period or epoch. In the example shown in FIG. 2, the fourth column 204₄ identifies the current demands and each of the remaining columns 204₅-204_{N+3} identify the predicted increase in demand for a future time period or epoch. Each requirement may be represented, for example, by a capacity or bandwidth value (e.g. 10 Gbps) or as a percentage increase in the demand of the previous time period (e.g. the demand for epoch 2 may be represented as a 10% increase of the demand for epoch 1).

It will be evident to a person of skill in the art that the demand matrix 200 of FIG. 2 is an example only and the demand matrix may comprise additional or alternative information; or the services and the requirements thereof may be represented in a different manner. For example, the demand matrix may also include routing rules/constraints that describe how a particular service is to be routed through the network.

While it is possible, using various techniques, to predict the demand growth, it is difficult, particularly for large networks, to determine, within a reasonable amount of time, an optimum topology to satisfy the predicted demand growth. For example, a large network may have hundreds of nodes and/or links which makes it an intractable task to manually analyze all of the possible changes to the network that can be made to accommodate the growth. Furthermore, the more time periods or epochs are used, the more time consuming and complicated the problem becomes. To address this issue, network operators typically model a predetermined percentage, X, growth and continually increase the capacity of all of the links so that utilization of each link never exceeds a predetermined percentage, Y (e.g. 50%). This quite often results in sub-optimal network topologies as it misses opportunities to move services onto larger and more cost effective links and thus reclaim (e.g. remove) other links and expensive equipment. Alternatively, network operators may overbuild the network often using expensive links when cheaper alternatives are available.

Accordingly, described herein are systems and methods for identifying an optimum network topology for each of a plurality of demand/growth scenarios In some cases the demand/growth scenarios are successively increasing (e.g. each demand/growth scenario has increased demands over the preceding demand/growth scenario) or successively decreasing (e.g. each demand/growth scenario has decreased demands over the preceding demand/growth scenario). However, in other cases the demand/growth scenarios may not have either pattern. In some examples, the methods and systems described herein comprise identifying the optimum network topology for the highest demand/growth scenario and then using the identified optimum network topology as a seed for determining the optimum network topology for the next highest demand scenario and so on.

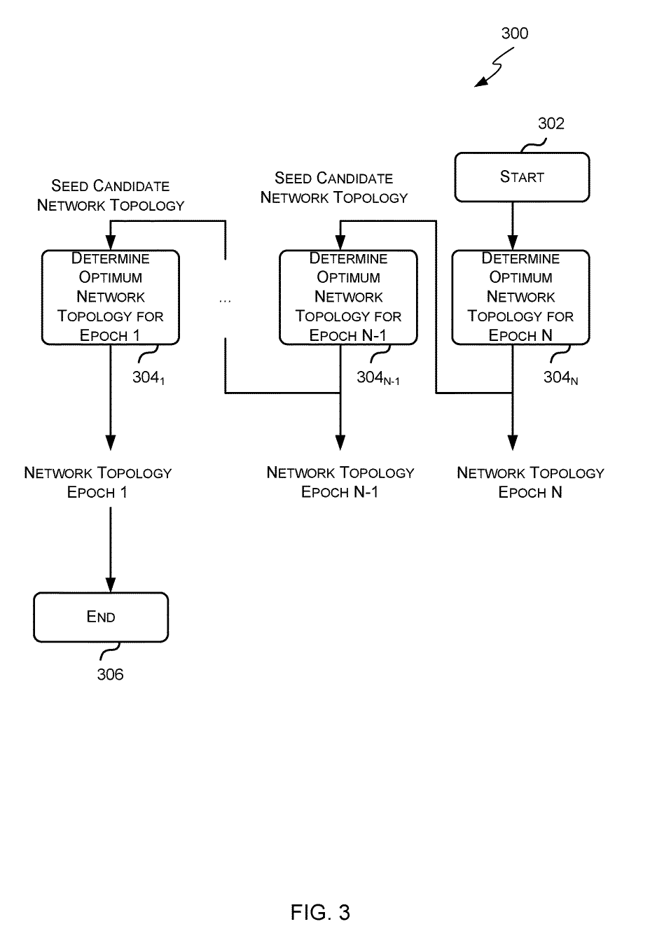

Reference is now made to FIG. 3 which illustrates a method 300 for determining the optimum network topology for each of a plurality of successively increasing demand/growth scenarios. Successively increasing demand/growth scenarios means that each demand/growth scenario has an increased demand/growth over the preceding demand/growth scenario. For example, the 10^{th} demand/growth scenario has increased demand over the 9^{th} demand/growth scenario. The output of the method 300 of FIG. 3 is, therefore, a set of optimum network topologies comprising an optimum network topology for each of the demand/growth scenarios.

The method 300 begins at block 302 and then proceeds to block 304_{N} where the optimum network topology is determined for the worst demand/growth scenario (e.g. the demand/growth scenario with the highest demand).

In the examples described herein each demand/growth scenario is related to a particular time period or epoch and will be referred to as the demand/growth scenario for epoch X where X indicates the order of the epoch relative to the other epochs. In some examples, the higher X is the higher the demands are. In these examples the highest number epoch has the highest or worst demand/growth scenario. Accordingly, where there are N epochs, epoch N will have the worst or highest demand/growth scenario. Therefore, in block 304_{N}, the optimum network topology is identified for the demand/growth scenario for the N^{th} epoch.

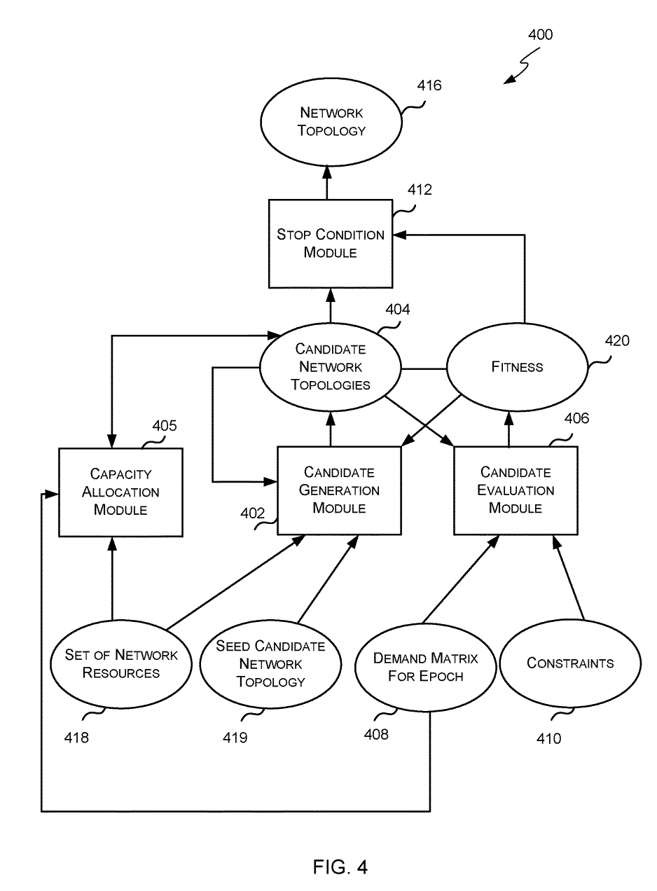

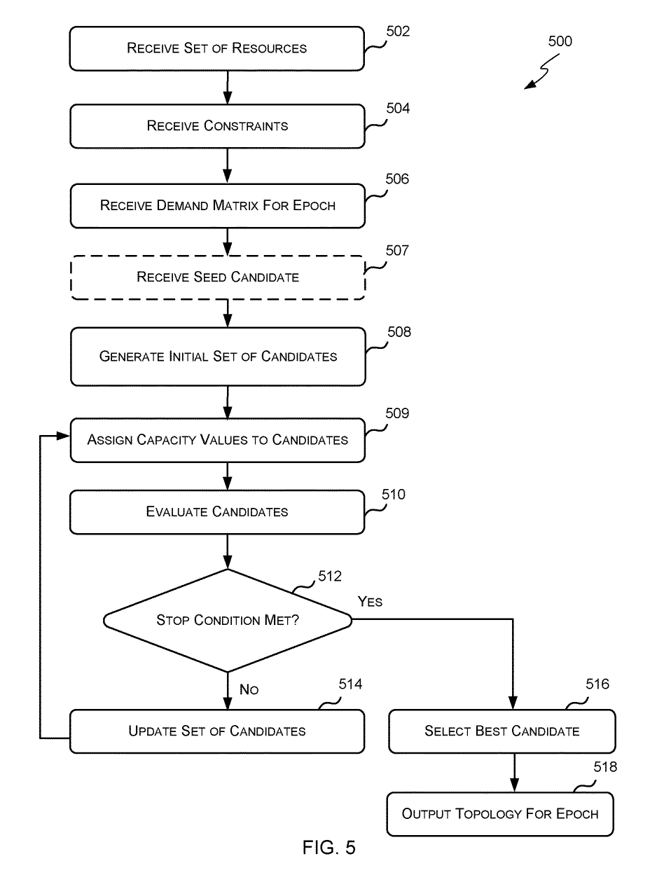

The optimum network topology for a particular demand/growth scenario may be identified using an iterative process. The iterative process comprises generating a set of candidate network topologies from a set of network resources; evaluating each of the candidate network topologies under the demand/growth scenario against one or more constraints; determining if at least one stop condition has been met (e.g. the candidate network topologies comprise an optimum network topology), and in response to determining no stop condition has been met evolving the set of candidate network topologies based on the evaluation and then repeating. An example system and method for determining the optimum network topology for a particular demand/growth scenario using an iterative process is described with reference to FIGS. 4 and 5 respectively.

Once the optimum network topology has been identified for the worst demand/growth scenario (e.g. epoch N), the method 300 proceeds to block 304_{N-1} where the optimum network topology for the next highest demand/growth scenario (e.g. epoch N−1) is determined using the optimum network topology for the worst demand growth scenario (e.g. epoch N) as a seed candidate network topology. Once the optimum network topology for the second worst demand/growth scenario (e.g. epoch N−1) has been identified the method proceeds to block 304_{N-2} (not explicitly shown) where the optimum network topology for the third highest demand/growth scenario (e.g. epoch N−2) is determined using the optimum network topology for the second highest demand/growth scenario (e.g. epoch N−1). This process is repeated until the optimum network topology is identified for the lowest demand/growth scenario (e.g. epoch 1) at block 304₁. Once the optimum network topology has been identified for the lowest demand/growth scenario (e.g. epoch 1) the method 300 ends 306.

Solving the worst case demand/growth scenario first and using that to seed the lower demand/growth scenarios significantly reduces the amount of time to generate the optimum network topologies for a plurality of successively increasing demand/growth scenarios. This is because the optimum network topology for the worst case demand/growth scenario (e.g. epoch N) provides the upper bound for the next highest growth/demand scenario (e.g. the optimum network topology) and so on. This reduces the subset of candidate network solutions to be analyzed to those candidate network topologies that fall within this upper bound (e.g. candidate network topologies that have the same links or less links than the optimum network topology for the next epoch). Accordingly, including the optimum network topology of the worst case scenario in the set of candidate network topologies for the next highest demand/growth scenario brings the set of candidate network topologies closer to the optimum network topology allowing the optimum network topology to be identified more efficiently and quickly.

For example, in one implementation of the method 300 of FIG. 3 it takes approximately 72 hours to determine the optimum network topology for a very large network (e.g. greater than 200 nodes) for a particular demand scenario using the iterative process described herein. Accordingly, without any seeding it would take 720 hours to calculate the optimum network topology for 10 different demand/growth scenarios. If, however, the optimum network topology for the worst demand/growth scenario is used to seed the next-worst (next highest) demand/growth scenario and so on the optimum network topology for 10 different demand/growth scenarios can be generated in 90 hours (including 72 hours to identify the optimum network topology for the worst demand/growth scenario). This results in an 87.5% reduction in the amount of time to generate the optimum network topologies.

Although the method of FIG. 3 is described in reference to successively increasing demand/growth scenarios, the method could equally be applied to successively decreasing demand/growth scenarios or a set of demand/growth scenarios that do not have a specified pattern. In all cases, the method would start with an optimization of the epoch with the highest demands and then an optimization of the epoch with the second highest demands and so on.

Reference is now made to FIG. 4 which illustrates an example system 400 for identifying an optimum network topology for a particular demand/growth scenario. The system 400 uses an iterative process to refine and evaluate candidate network topologies to identify the optimum network topology for the particular demand/growth scenario.

The system 400 comprises a candidate generation module 402 for generating and iteratively evolving a set of candidate network topologies 404; a capacity allocation module 405 for assigning capacity values to the links of the candidate network topologies 404; a candidate evaluation module 406 for evaluating the candidate network topologies 404 to determine how well, for the demand/growth scenario set out in the demand matrix 408, they meet one or more constraints 410; a stop condition module 412 for determining, based on the evaluation of the candidate network topologies, when the iterative process can be stopped and then selecting the best candidate network topology as the optimum network topology 416.

The candidate generation module 402 receives a set of network resources 418 and generates a set of candidate network topologies 404. In some cases the candidate generation module 402 may also receive a seed candidate network topology 419. As described above, the seed candidate network topology is the optimum network topology for the subsequent demand/growth scenario. The seed candidate network topology is designed to bring the set of candidate network topologies 404 closer to the optimum network topology sooner. More particularly, the seed candidate network topology is used to guide the evolution of the candidate network topologies, thus improving the performance (in terms of computational expense and time) of this highly complex optimization problem.

The set of network resources 418 comprises all of the components that may form the network and the possible configurations thereof. For example, the set of network resources 418 may comprise all of the possible nodes in the network, all of the potential links in the network, all of the possible capacity options for each link in the network, and/or all of the possible hardware components that can be used to form the network. Since the optimum network topology (e.g. network topology 108 or 110) is based on an existing network topology (e.g. network topology 102) the set of network resources 418 also identifies which nodes and links (and, optionally the hardware components that form each) are part of the existing network topology along with their existing capacity (e.g. bandwidth).

The set of network resources may be generated by the user based on the options available to them to modify their network. For example, the nodes may represent datacenters and the links between them may be the full list of options they have for linking two (or more) datacenters together. Such options may include, microwave links, satellite links, laying their own fiber, renting fiber, or renting capacity on a third party's fiber/microwave/satellite links.

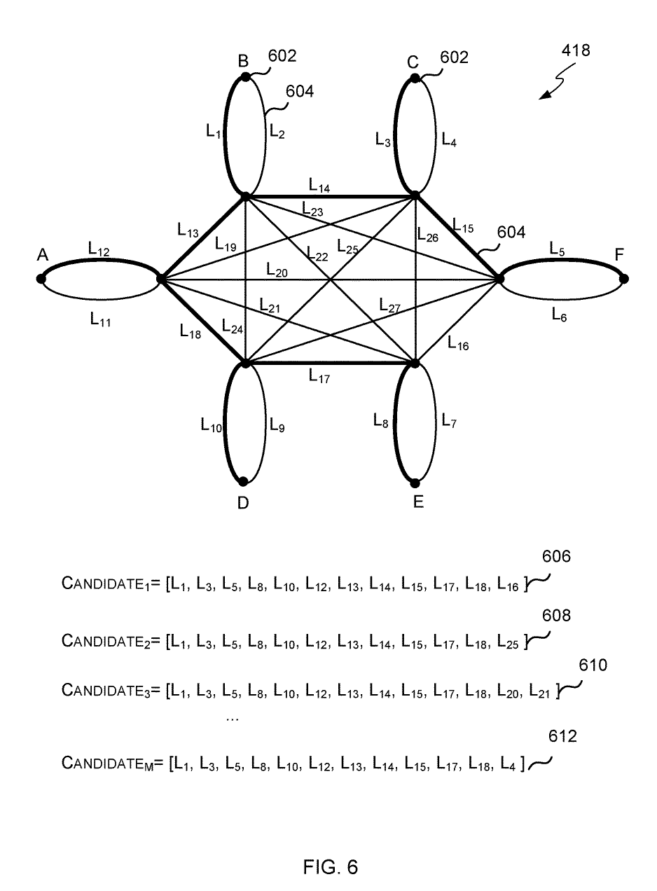

The candidate generation module 402 takes the set of network resources 418 and generates an initial set of candidate network topologies 404. Each candidate network topology comprises a set of nodes and links from the set of network resources 418 that form a network topology. In some cases the candidate network topologies may be represented by a vector that comprises a list of the links forming the topology. Example candidate network topologies are described with reference to FIG. 6.

Where the candidate generation module 402 has not received a seed candidate network topology 419 (e.g. where the optimum network topology for the worst demand/growth scenario (e.g. epoch N) is being identified), the candidate generation module 402 generates a predetermined number M, in one example 50, candidate network topologies 404. The predetermined number (M) of candidate network topologies may be selected based on the number of resources available.

Where, however, the candidate generation module 402 has received a seed candidate network topology 419 (e.g. where the optimum network topology for a demand/growth scenario that is not the worst demand/growth scenario) the candidate generation module 402 generates M−1 candidate network topologies 404 and uses the seed candidate network topology as the M^{th} candidate network topology.

In some cases each of the candidate network topologies generated by the candidate generation module 402 comprises all of the links forming the existing network and a randomly selected subset of the remaining links in the set of network resources 418.

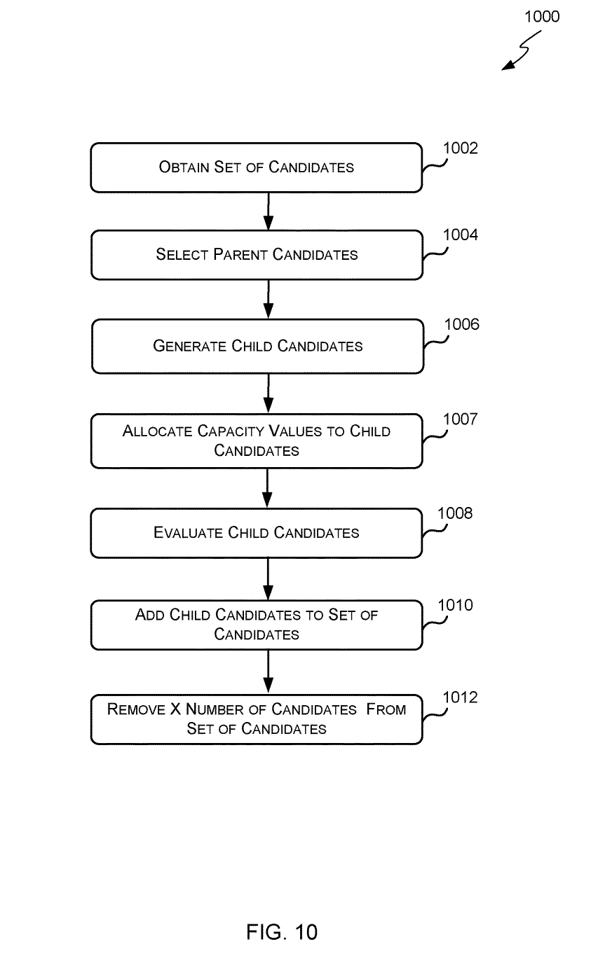

The candidate generation module 402 is also configured to periodically update or evolve the set of candidate network topologies 404 by selecting one or more candidate network topologies from the set of candidate network topologies 404, forming new candidate network topologies from the selected candidate network topologies (e.g. via mutation, mating (e.g. crossover), and/or a combination thereof), and replacing some of the candidate network topologies with the new candidate network topologies. In some cases the new candidate network topologies replace the poorest candidate network topologies in the set if they are better. In other cases, the candidate network topologies that are replaced by the new candidate network topologies may be selected using other criteria. For example, the candidate network topologies that are replaced by the new candidate network topologies may be randomly selected from the set of candidate network topologies. An example method for updating or evolving the set of candidate network topologies 404 that may be executed by the candidate generation module 402 is described with reference to FIGS. 10-12.

The capacity allocation module 405 assigns a capacity (e.g. bandwidth) value to each link of the candidate network topologies 404. In some cases assigning capacity (e.g. bandwidth) values to the links of a candidate network topology comprises determining the best route for each service through the candidate network topology. The best route for a service comprises a set of links that the traffic traverses to get from the start node to the end node. The best route for each service may be determined by a generic routing engine (GRE) through an iterative process. The iterative process may comprise generating a set of candidate service routings, evaluating the candidate service routings to determine how well they satisfy the routing constraints specified in the demand matrix and/or requirements for each service and evolving the set of candidate service routings until a stop condition has been met. Alternatively, the services may be routed using a known routing algorithm such a Border Gateway Protocol (BGP), Internet Protocol (IP), IP with equal-cost multi-path (ECMP), least cost, or constrained shortest path first (CSPF).

Once the routing of the services has been determined, the utilization of each link is determined for the epoch or demand/growth scenario being evaluated. A capacity (e.g. bandwidth) value is then assigned to each link to satisfy the utilization of that link for that epoch. For example, if the utilization of a link is 10 Gbps for a particular demand/growth scenario, a capacity (e.g. bandwidth) value of at least 10 Gbps is assigned to the link for that demand/growth scenario.

In some cases the capacity allocation module 405 may also take into account maximum utilization values that have been assigned to one or more of the links when assigning capacity (e.g. bandwidth values). For example, if a particular link has been assigned a maximum utilization of 25% then a calculated utilization of 10 Gbps would result in a capacity value of at least 40 Gbps being assigned to the link.

In some cases the best route for the services is determined for the candidate network topology in steady-state (e.g. all links are active). In other cases the best route for the services is also determined for the candidate network topology in one or more failure states (e.g. under one or more failure conditions). A failure condition may be one or more network failures, such as failure of a link, node, shared risk group etc., during which services unaffected by the failure are not re-routed and services affected by the failure are only re-routed if they are protected. In cases where the best route for the services is determined for the candidate network topology in steady state and in one or more failure states a bandwidth value is assigned to each link to satisfy the maximum utilization of that link for that demand/growth scenario in both steady state and the one one or more failure states. For example, if the utilization of a link is 10 Gbps for a particular demand/growth scenario in steady state, and 25 Gbps for the particular demand/growth scenario in a failure state then a capacity value of at least 25 Gbps is assigned to the link for that demand/growth scenario.

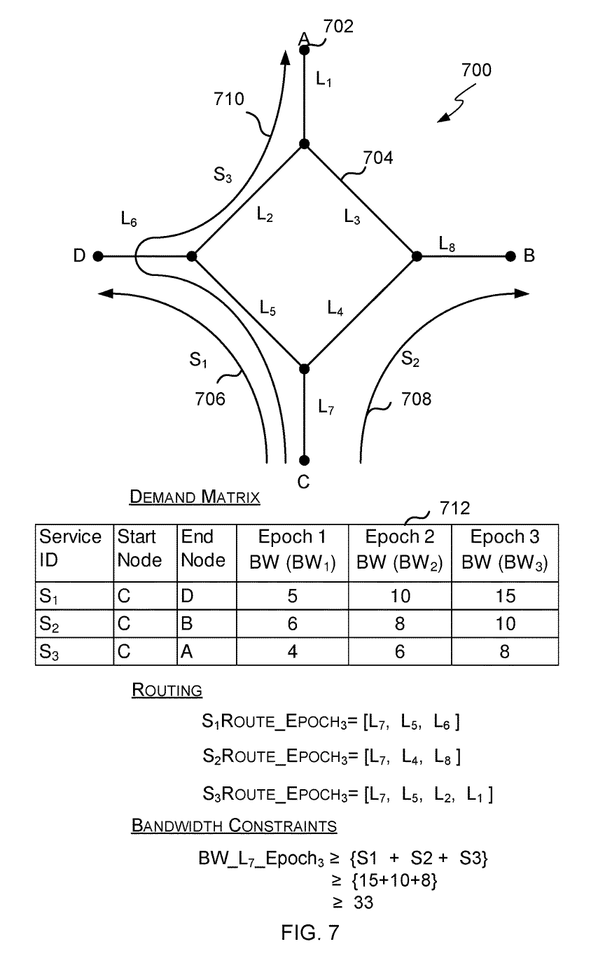

An example method for assigning bandwidth values to a candidate network topology is described with reference to FIG. 7.

The candidate evaluation module 406 evaluates each of the candidate network topologies (including the service routing and capacity values identified by the capacity allocation module 405) 404 based on how well the candidate network topology meets the one or more specified constraints (which typically includes the cost of the topology) when operating in the demand/growth scenario specified in the demand matrix 408.

The set of constraints 410 includes one or more features (referred to as a constraint) that the candidate network topologies are evaluated against. The set of constraints may be determined by the user/owner of the network, based on the way in which they wish to optimize their network topology. For example, one user may wish to generate the cheapest (in monetary terms) network that can support their demands; another user may wish to generate the topology that provides the lowest latency regardless of the monetary cost; and yet another user may wish to achieve the best latency for a given cost.

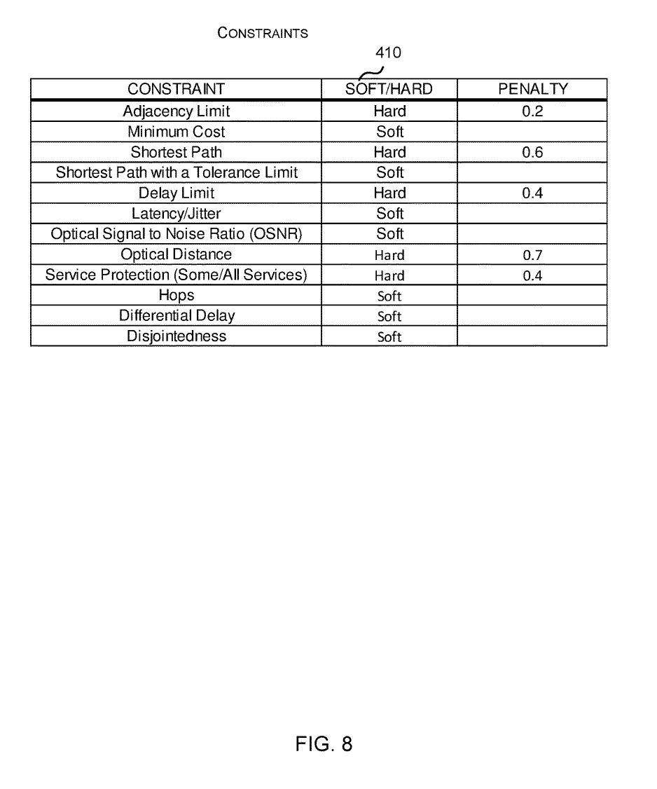

The constraints may be classified as being either hard constraints or soft constraints. A hard constraint must be satisfied for the candidate network topology to be a viable network topology. Accordingly the candidate evaluation module 406 will not consider a candidate network topology that does not satisfy a hard constraint as meeting the constraint(s) very well. Example hard constraints include, but are not limited to, minimum bandwidth, maximum delay, and adjacency limit. In contrast, a soft constraint is preferred and ideally should be optimized, but is not required. Example soft constraints include, but are not limited to, minimize cost and minimize delay. Example constraints will be described in more detail with reference to FIG. 8.

Not all constraints may be of equal importance, so in some cases the set of constraints 410 may comprise, in addition to a listing of the constraints themselves, weights indicating the relative importance of the constraints.

As described above, the demand matrix 410 sets out one or more demand/growth scenarios. In particular the demand matrix 410 provides a list of services to be routed through the network and the requirements of the service for one or more time periods or epochs. Only the demands for the relevant epoch or time period are used to evaluate the candidate network topologies 404.

As described above, a service represents traffic/information/data that is sent from one node in a network (e.g. the start or source node) to another (e.g. the end or destination node). The requirement of a service is the amount of traffic/information/data sent from the start node to the end node. An example demand matrix 200 was described with reference to FIG. 2.

In some cases the candidate evaluation module 406 is configured to generate a fitness value 420 for each candidate network topology (including the routing of services and capacity values identified by the capacity allocation module 405) based on the relevant demand/growth scenario (e.g. the service requirements for a particular epoch) specified in the demand matrix 408 and the set of constraints 410. The fitness value 420 provides a quantitative measure of how well the candidate network topology meets the constraints 310 for the relevant demand/growth scenario. In some cases, the higher the fitness value the better the candidate, and the lower the fitness value the poorer the candidate. In some cases the fitness value is a number between 0 and 1 where 1 indicates an optimum candidate and 0 indicates a very poor candidate.

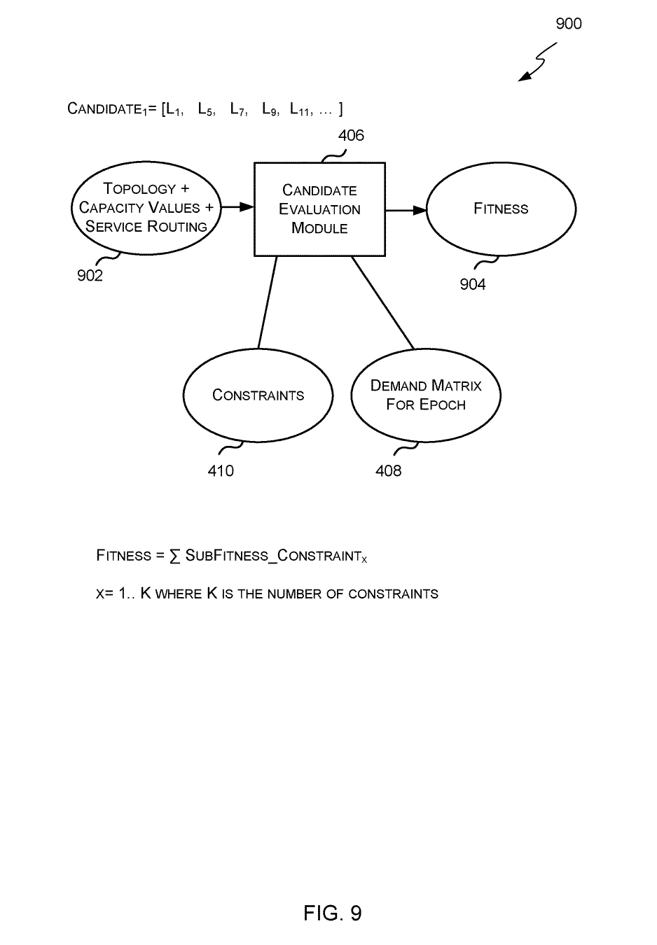

The fitness value for a particular candidate network topology (including the service routing and capacity values identified by the capacity allocation module 405) may be computed by calculating a sub-fitness value for each constraint; and combining the sub-fitness values (e.g. summing or averaging). In some cases the constraints are not of equal importance so the fitness value may take into account the relative importance of the constraints. For example, the fitness value may be a weighted sum or a weighted average of sub-fitness values where the weight used for each sub-fitness value indicates the relative importance of the corresponding constraint. An example method for generating a fitness value for a candidate network topology is described with reference to FIG. 9.

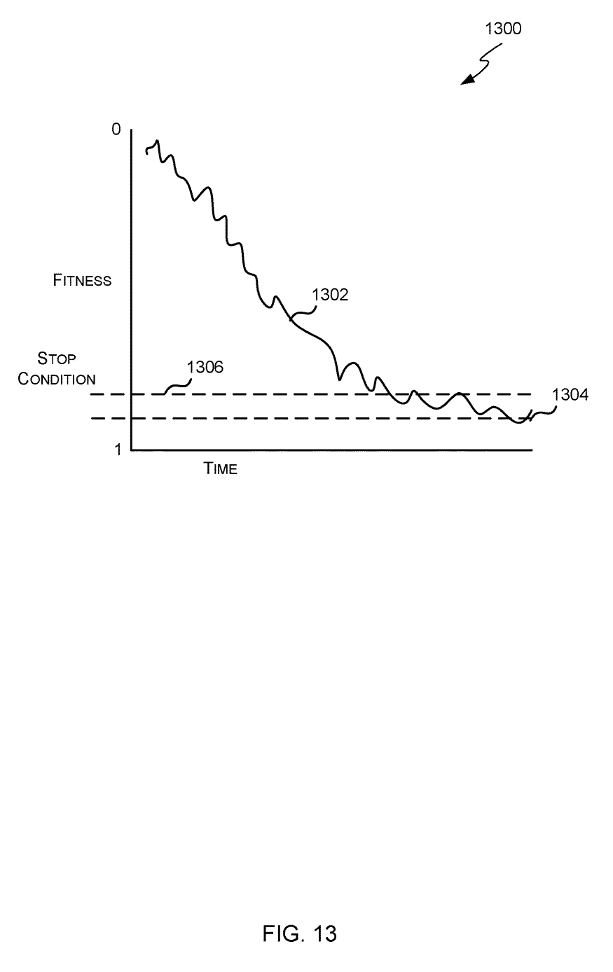

The stop condition module 412 determines when the iterative process of evaluating and updating/evolving the candidate network topologies 404 can end. In particular, the stop condition module 412 determines that the iterative process can stop if at least one stop condition has been met. One or more stop conditions may indicate that a sufficiently optimum network topology has been identified For example, the stop conditions may comprise one or more of: if the best fitness value in the set of fitness values 420 is within a predetermined percentage, Q, of the predicted optimum fitness value; if the best fitness value in the set of fitness values 420 has not improved or changed after a predetermined number, R, of iterations; or if the best fitness value has a percentage likelihood of being the optimum fitness value over a predetermined threshold. An example stop condition will be described with reference to FIG. 13.

If the stop condition module 412 determines that at least one stop condition is met the stop condition module 412 selects the candidate network topology or topologies that has/have the best fitness value and outputs the selected candidate network topology/topologies as the optimum network topology 416.

Reference is now made to FIG. 5 which illustrates a method 500 for identifying an optimum network topology for a particular demand/growth scenario using the system 400 of FIG. 4. The method identifies an optimum network topology through an iterative process that generates a set of candidate network topologies, evaluates the candidates, and evolves or updates the set of candidate network topologies to create a set of stronger candidate network topologies. Since the quality of the candidate network topologies increases after each iteration, each iteration increases the probability that the set of candidate network topologies comprises the optimum network topology.

The method 500 begins at block 502 where the candidate generation module 402 receives the set of network resources 418. As described above, the set of network resources 418 comprises all of the potential components of the network and the possible configurations thereof which can be used to build the network topology. For example, the set of network resources 418 may comprise all of the possible nodes in the network, all of the potential links in the network, all of the possible capacity options for each link in the network, all of the possible hardware components that can be used to form the network etc. The set of network resources 418 also identifies which nodes and links are part of the existing network and the existing capacity of these links. Once the set of network resources 418 have been received the method 500 proceeds to block 504.

At block 504, the candidate evaluation module 406 receives the set of constraints 410. As described above, the set of constraints 410 specify the features of the network topology that are used to evaluate the quality of a candidate network topology. The set of constraints may comprise one or more hard constraints which must be met for a candidate network topology to be viable and/or one or more soft constraints which are to be optimized, but are not required. The constraints may not be of equal importance and thus each constraint may be associated with a weight value that indicates its relative importance with respect to the other constraints. Once the set of constraints have been received the method 500 proceeds to block 506.

At block 506, the candidate evaluation module 406 receives the demand matrix 408. As described above, the demand matrix 408 provides a list of services to be routed through the network and the requirement of each service for one or more demand/growth scenarios. As described above, a service represents traffic/information/data that is sent from one node (i.e. the start or source node) in a network to another (i.e. the end or destination node). The requirement of a service is the amount of traffic/information/data that is sent from the start node to the end node. As described above, the demand matrix 408 may also include routing rules/constraints that describe how a particular service is to be routed through the network. Once the demand matrix 408 has been received the method 500 proceeds to block 507 or block 508.

At block 507, the candidate generation module 402 receives a seed candidate network topology 419. As described above the seed candidate network topology is the optimum network topology for the subsequent demand/growth scenario. For example, if the optimum network topology for epoch 4 is currently being identified then the seed candidate network topology is the optimum network topology for epoch 5. Once the seed candidate network topology 419 has been received the method 500 proceeds to block 508.

It will be evident to a person of skill in the art that blocks 502 to 507 may be executed in any order or in parallel. For example, the system 400 may concurrently receive the set of network resources 418, the service demand matrix 408, the set of constraints 410 and the seed candidate network topology 419.

At block 508, the candidate generation module 402 creates an initial set of M (e.g. 50) candidate network topologies 404 from the set of network resource 418. Each candidate network topology comprises a subset of the nodes and links of the set of network resources 418. In some cases each candidate network topology is represented by a vector of links. The term “vector” is used herein to mean an ordered or unordered list of elements. An example set of candidate network topologies is described with reference to FIG. 6.

Where the candidate generation module 402 has received a seed candidate network topology then the initial set of candidate network topologies comprises the seed candidate network topology and M−1 candidate network topologies generated by the candidate generation module 402 from the set of network resources 418. Where, however, the candidate generation module 402 has not received a seed candidate network topology then the initial set of candidate network topologies comprises M candidate network topologies generated by the candidate generation module 402 from the set of network resources 418.

In some cases each of the candidate network topologies generated by the candidate generation module 402 comprises all of the links forming the existing network topology and a randomly selected subset of the remaining links in the set of network resources 418.

Once the initial set of candidate network topologies has been created the method 500 proceeds to block 509.

At block 509, the capacity allocation module 405 assigns a capacity (e.g. bandwidth) value to each link of the candidate network topologies. As described above with reference to FIG. 4, assigning capacity (e.g. bandwidth) values to the links of a candidate network topology may comprise determining the best route for each service through the candidate network topology.

The best route for a service comprises a set of links that the traffic traverses to get from the start node to the end node. The best route for each service may be determined by a generic routing engine (GRE) through an iterative process. The iterative process may comprise generating a set of candidate service routings; evaluating the candidate service routings to determine how well they satisfy the routing constraints specified in the demand matrix 408 and/or requirements for each service; and evolving the set of candidate service routings until a stop condition has been met. Alternatively, the routing of the services may be determined using a known routing algorithm such a Border Gateway Protocol (BGP), Internet Protocol (IP), IP with equal-cost multi-path (ECMP), least cost, or constrained shortest path first (CSPF).

Once the routing of the services through the candidate network topology has been determined the utilization of each link for the demand/growth scenario (e.g. epoch) is then determined from the requirements in the demand matrix 408 for that demand/growth scenario. A bandwidth is then assigned to each link to satisfy the utilization. For example, if the utilization of a link is 10 Gbps, a capacity (e.g. bandwidth) value of at least 10 Gbps is assigned to the link.

The actual capacity (e.g. bandwidth) value assigned may be based on the information in the set of network resources 418. In particular, the set of network resources 418 may specify the incremental increases in capacity that can be made for any particular link. For example, the set of network resources 418 may specify that a particular link may only be increased by 10 Gbps or 100 Gbps increments. The set of network resources 418 may also specify a maximum utilization value for one or more of the links. For example, if a particular link is assigned a maximum utilization of 33.33% then a calculated utilization of 10 Gbps results in a capacity value of at least 30 Gbps being assigned to the link.

In some cases the best route is determined for the candidate network topology in steady-state (e.g. all links are active). In other cases the best route is determined for the candidate network topology in steady state and in one or more failure states (i.e. under one or more failure conditions). A failure condition may be one or more network failures, such as failure of a link, node, shared risk group etc., during which services unaffected by the failure are not re-routed and services affected by the failure are only re-routed if they are protected. Where the best route is determined for both steady state and one or more failure conditions the minimum bandwidth for a link is based on the maximum utilization of the link in steady state and one or more failure conditions. For example, if the utilization of a link in steady state is 20 Gbps and the maximum utilization of the link in a failure state is 35 Gbps then the capacity (e.g. bandwidth) value assigned to the link must be at least 35 Gbps.

Once capacity (e.g. bandwidth) values are assigned to the links of the candidate network topologies the method 500 proceeds to block 510.

At block 510, the candidate evaluation module 406 evaluates each candidate network topology (including the service routing and capacity values identified in block 509) 404 against the set of constraints 410 and the demand/growth scenario specified by the demand matrix 408. In some cases evaluation of a candidate network topology comprises assigning the candidate network topology a fitness value 420 that is a quantitative measure of how well the candidate network topology meets the constraint(s) 410 for the demand/growth scenario specified by the demand matrix 408.

As described above, in some cases generating a fitness value for a candidate network topology may comprise generating a sub-fitness value for each constraint where each sub-fitness value is a quantitative measure of how well the candidate network topology meets the particular constraint; and combining (e.g. summing or averaging) the sub-fitness values to generate the fitness value. An example method for generating a fitness value is described with reference to FIG. 9.

The candidate network topologies may be evaluated (e.g. assigned a fitness value) serially or in parallel. For example, in some cases the candidate network topologies are evaluated in parallel and in other cases the candidate network topologies are evaluated one at a time.

Once the set of candidate network topologies 404 have been evaluated, the method 500 proceeds to block 512.

At block 512 the stop condition module 412 determines whether at least one stop condition has been met and the iterative process can stop. The stop condition(s) may be, for example, if the best fitness value in the set of fitness values 420 is within a predetermined percentage, Q, of the predicted optimum fitness value; if the best fitness value in the set of fitness values has not improved or changed after a predetermined number, R, of iterations; and/or the likelihood that the best fitness value in the set of fitness values is above a predetermined threshold. It will be evident to a person of skill in the art that these are examples only and other stop conditions may be used.

If the stop condition module 412 determines that none of the stop conditions have been met then the method 500 proceeds to block 514. If, however, the stop condition module 412 determines that at least one stop condition has been met then the method 500 proceeds to block 516.

At block 514, the candidate generation module 402 updates or evolves the set of candidate network topologies in an attempt to increase the quality of the candidate network topologies in the set. In particular, it is very unlikely that the initial set of candidate network topologies comprises the optimum network topology therefore the set of candidates is evolved to pull the candidate network topologies closer to the optimum network topology.

In some cases evolving the set of candidate network topologies comprises selecting one or more of the candidate network topologies, generating one or more new candidate network topologies from the selected candidate network topologies and replacing some of the candidate network topologies in the set with the new candidate network topologies. In some cases the new candidate network topologies only replace candidate network topologies in the set if the new candidate network topologies are better (e.g. based on a fitness value) than candidate network topologies in the set.

For example, in some cases the candidate generation module 402 is configured to select a plurality of parent candidate network topologies from the set of candidate network topologies. The parent candidate network topologies may be the candidates with the best fitness values or they may be selected using other criteria or methods (e.g. they may be randomly selected). The candidate generation module 402 then generates one or more child candidate network topologies from the parent candidate network topologies using known techniques such as mating, mutation or a combination thereof. The candidate generation module 402 then adds the child candidate network topologies to the set of candidate network topologies.

The method 500 then proceeds back to blocks 509 and 510 where the capacity allocation module 405 allocates capacity values to the links of the child candidate network topologies and the candidate evaluation module 406 evaluates (e.g. assigns a fitness value to) each of the child candidate network topologies. The candidate evaluation module 406 then updates the set of candidate network topologies to include only M candidate network topologies where M is the number of candidate network topologies initially generated in block 508. In some cases the best M candidate network topologies are selected. In other cases M candidate network topologies are randomly selected. This process of evolving the set of the candidate network topologies is repeated until a stop condition is satisfied in block 512. An example method for updating or evolving the set of candidate network topologies is described with reference to FIGS. 10 to 12.

At block 516, once a stop condition has been met, the stop condition module 412 selects the best candidate network topology (e.g. the candidate network topology with the best fitness value). Once the best candidate network topology has been selected the method 500 proceeds to block 518.

At block 518 the selected/best candidate network topology and the bandwidth values assigned thereto are output as the optimum network topology for the demand/growth scenario (e.g. epoch).

Reference is now made to FIG. 6 which illustrates an example method for generating a candidate network topology based on a set of network resources. In particular FIG. 6 shows an example of the nodes 602 and links 604 that form a set of network resources 418. Each link 604 is assigned a label or identifier (L₁ . . . L₂₇) which uniquely identifies the link—e.g. identifies which two nodes it connects.

A candidate network topology comprises the links 604 forming the existing network topology (L₁, L₃, L₅, L₈, L₁₀, L₁₂, L₁₃, L₁₄, L₁₅, L₁₇ and L₁₈) and any combination of the remaining links 604. The candidate network topology may be represented by an array or vector listing of its links. In one example, as shown in FIG. 6, the array or vector may comprise a list of link identifiers. In this example, the order of the links is not relevant since it is the identifier that identifies the link. In another example, the array or vector may comprise a bit for each possible link and when that link has been selected as part of the candidate the bit is set, otherwise the bit is cleared. In this example, the order of the information in the array or vector is relevant as certain bits map back to certain links.

Accordingly, the candidate generation module 402 may be configured to generate the initial set of candidate network topologies 606, 608, 610, 612 by randomly selecting a number of links of the set of possible links and saving the selected link identifiers for the randomly selected links and the links forming the existing network topology in an array or vector. The candidate network topologies do not have to have the same number of links and in fact they are likely to have different numbers of links. For example, FIG. 6 illustrates several candidate network topologies 606, 608, 610, 612 that may be generated from the set of network resources 418 illustrated in FIG. 6. The first example candidate network topology 606 comprises link L₁₆ in addition to the existing links; the second example candidate network topology 608 comprises link L₂₅ in addition to the existing links; the third example candidate network topology 610 comprises links L₂₀, and L₂₁ in addition to the existing links; and the M^{th} example candidate network topology 612 comprises link L₄ in addition to the existing links.

Reference is now made to FIG. 7 which illustrates assigning bandwidth values to a candidate network topology 700. In FIG. 7 the candidate network topology 700 comprises eight nodes 702 (including four edge nodes A, B, C and D) and eight links (L₁-L₈) 704 connecting the nodes. There are three services S₁ 706, S₂ 708 and S₃ 710 running over the network. The first service S₁ 706 sends traffic from node C to node D, the second service S₂ 708 sends traffic from node C to node B, and the third service S₃ 710 sends traffic from node C to node A. The requirement of each service for each of three time periods or epochs is set out in a demand matrix 712.

To allocate bandwidth values to each link 704 of the candidate network topology 700, first the best route (the set of links traversed to get from the source node to the destination) for each service is determined using, for example, a generic routing engine (GRE) or a known routing protocol as described above.

In the example of FIG. 7, it is determined that the first service S₁ 706 is routed from node C to node D via L₇, L₅ and L₆; the second service S₂ 708 is routed from node C to node B via L₇, L₄, and L₈; and the third service S₃ 710 is routed from node C to node A via L₇, L₅, L₂ and L₁.

Next it is determined, for each link, the amount of traffic that will run over that link in the relevant demand/growth scenario (e.g. epoch). In particular, the amount of traffic that will run over a link will be equal to the sum of the requirements for each service that runs over the link. For example, all three services S₁, S₂ and S₃ run over L₇ thus in epoch 3 the bandwidth for L₇ is 33 (15+10+8). A capacity (e.g. bandwidth) value is assigned to the link to satisfy the utilization. For example, a bandwidth at least 33 is assigned to L₇. Where the link is an existing link this comprises increasing the capacity (e.g. bandwidth). Whereas if the link is a new link a new capacity (e.g. bandwidth) value is assigned.

In some cases maximum utilization values are assigned to one or more of the links which may be taken into account in assigning capacity (e.g. bandwidth) values to the links. For example, if a particular link is assigned a maximum utilization of 33.33% then a calculated utilization of 10 Gbps would result in a capacity value of at least 30 Gbps being assigned to the link. The maximum utilization values may be set out in the set of network resources 418.

The actual capacity (e.g. bandwidth) values that can be assigned to a particular link may be set out in the set of network resources. For example, set of network resources may specify that the bandwidth on a certain link may only be increased in increments of 10 Gbps or 100 Gbps.

In some cases the best route for each service is determined for the candidate network topology both in steady state (e.g. all links and nodes are active) and in one or more failure states (e.g. one or more nodes and/or links is deemed inactive). In these cases the amount of traffic over each link in each state is then determined. The maximum traffic or utilization for a particular link is the maximum traffic or utilization over all states.

Reference is now made to FIG. 8 which illustrates an example set of constraints 410. As described above the constraints outline the metrics or features for evaluating the candidate network topologies. For example, the set of constraints 410 of FIG. 8 include the following: adjacency limit, minimum cost, shortest path; shortest path with tolerance; delay limit, latency/jitter, optical signal to noise ratio (OSNR); optical distance; service protection; hops; differential delay and disjointedness.

An adjacency limit constraint specifies that the number of adjacent nodes is to be limited. This limit may be required due to a hardware limit (e.g. maximum number of cards) etc. A minimum cost constraint specifies that the minimum routed cost solution should be selected. A shortest (distance) path constraint specifies that the shorted route should be selecting when routing services. The user may be able to specify an acceptable tolerance limit so that the absolute shortest path does not always have to be taken, but a route that is within the tolerance of being the shortest path is acceptable. The delay limit constraint specifies the maximum amount of delay between transmission and receipt of service traffic. The latency/jitter constraint specifies that latency or jitter should be minimized. The OSNR constraint specifies that OSNR should be optimized. The optical distance specifies that the maximum distance for optical links cannot be exceeded (otherwise the optical link will not work or needs to be regenerated incurring additional expense and network complexity). The service protection constraint specifies that there should be a backup route available in case the main route has a failure. This constraint can be specified for all or only some of the services. The hops protection constraint specifies that the number of hops between start and end nodes should be minimized. The differential delay constraint specifies that the difference in delay between two or more services should be minimized. The disjointedness constraint specifies that there should be no shared links, nodes, and/or shared risk groups (SRGs) between one or more disjoint services.

The constraints may be classified as being either hard constraints or soft constraints. A hard constraint must be satisfied for the candidate network topology to be a viable solution. Accordingly a candidate network topology that does not satisfy a hard constraint will have a poor fitness value. Hard constraints usually specify a particular threshold that has to be met. In the example set of constraints in FIG. 8, the adjacency limit, shortest path limit (without a tolerance), delay limit, optical distance and service protection constraints are hard constraints. All the other constraints are soft constraints.

Each hard constraint may be assigned a penalty value which is used in calculating the fitness value for when the constraint is not met. This is used to push the fitness value to a poorer or less favorable value when a candidate network topology does not meet a hard constraint.

It will be evident to a person of skill in the art that the constraints illustrated in FIG. 8 are examples only and any other routing, topology or other type of constraint may be used or specified.

Reference is now made to FIG. 9 which illustrates an example method 900 for evaluating a candidate network topology (including the service routings and capacity values identified by the capacity allocation module 405) 902 which may be executed by the candidate evaluation module 406. In particular, in the example method 900 the candidate evaluation module 406 may be configured to evaluate a candidate network topology (including the service routings and capacity values identified by the capacity allocation module 405) 902 by generating a fitness value 904 for the candidate network topology 902 where the fitness value 904 is a quantitative measure of how well the candidate network topology 902 meets the specified constraints 410 for the demand/growth scenario specified by the demand matrix 408. In other words the fitness value 904 defines how “good” a candidate network topology is and thus can be used to rank candidate network topologies.

The fitness value 904 may be a number between 0 and 1 where 1 indicates the best network topology and 0 indicates a poor network topology (or vice versa). However, it will be evident to a person of skill in the art that this is an example only and that the fitness value 904 may be generated to fall in a different range.

In some cases the fitness value 904 may be generated by calculating a sub-fitness value for each constraint and determining the average of the sub-fitness values. For example, the fitness value 904 may be calculated using equation (1) shown below:

$$Fitness Value = {\sum }_{x = 1}^{k} ( \frac{{SubFitnessValue}_{x}}{k} ) \qquad ( 1 )$$

where k is the number of constraints.

As described above, not all constraints may be of equal importance and so in some cases the fitness value 904 may be calculated from a weighted average of the sub-fitness values (the fitness values for each constraint) where the weights are assigned based on the relative importance of the corresponding constraints. For example, the fitness value may be calculated using equation (2) shown below:

$$Fitness Value = {\sum }_{x = 1}^{k} ( \frac{{SubFitnessValue}_{x} * {Weight}_{x}}{k} ) \qquad ( 2 )$$

where k is the number of constraints, and Weightₓ is the weight assigned to the x^{th} constraint.

Each sub-fitness value may be generated from a corresponding fitness function that assesses how well the network topology meets the corresponding constraint. Where the constraint is a hard constraint (e.g. a specific upper or lower limit is specified for the constraint) and the candidate network topology 902 does not meet the constraint, then a penalty may be assessed against the sub-fitness value. For example, the fitness value may be adjusted based on the penalty value according to formula (3) shown below:

SubFitnessValue=SubFitnessValue*(Penalty^{Number of Failures}) (3)

where Penalty is a value between 0 and 1 and Number of Failures is the number of times the candidate network topology failed to meet the constraint. For example, if the hard constraint was a maximum number of adjacencies then each time the candidate network topology exceeded the maximum number of adjacencies then the Number of Failures is increased.

Each sub-fitness value (a value indicating the fitness for a particular constraint) may be calculated in accordance with a fitness function. Accordingly, if the constraints comprise a cost constraint, a utilization constraint, delay constraint, speed constraint, efficiency constraint, and a disjointed constraint then there may be corresponding cost, utilization, delay, speed, efficiency and disjointed fitness functions.

A disjointed fitness function determines whether the routes through the candidate network topology for disjointed services share any links and/or nodes. The disjointed fitness function may be configured so that any sharing of links and/or nodes between the routes of disjointed services results in a decrease in the fitness value for the candidate network topology. A cost fitness function may compute the sum of the costs of a route on a network topology and compare this to an expected minimum cost/maximum cost of a route from the same start node to the same end node. Existing network links may be assigned a cost of zero as they are sunk costs or they may be assigned a fixed cost.

Reference is now made to FIG. 10 which illustrates an example method 1000 for evolving the set of candidate network topologies which may be executed by the candidate generation module 402, the capacity allocation module 405, and the candidate evaluation module 406. The objective of the evolving is to increase the quality of the candidate network topologies 404. The example method 1000 of FIG. 10 comprises identifying one or more parent candidate network topologies in the set of candidate network topologies, generating child candidate network topologies from the parent candidate network topologies, evaluating the child candidate network topologies, adding the child network topologies to the set of candidate network topologies and selecting the M candidate network topologies from the combined set to continue. In some cases, the best M candidate network topologies (based on the fitness values) are selected, in other cases M candidate network topologies are selected randomly, and yet other cases the best N candidate network topologies are selected (based on the fitness values) and M-N random candidate network topologies are selected.

The method 1000 starts at block 1002 where the candidate generation module 402 obtains the current set of candidate network topologies 404. Once the current set of candidate network topologies 404 has been obtained, the method 1000 proceeds to block 1004.

At block 1004, the candidate generation module 402 selects a predetermined number, in one example 2, of parent candidate network topologies from the set of candidate network topologies 404. The parent candidate network topologies may, for example, be selected based on their associated fitness value (e.g. the best candidate network topologies based on their fitness values may be selected as the parents), or they may be selected using other criteria and/or methods (e.g. they may be randomly selected or they may be selected based on a weighted random method). Once the parent candidate network topologies have been selected the method 1000 proceeds to block 1006.

At block 1006, the candidate generation module 402 generates one or more child candidate network topologies from the parent candidate network topologies selected in block 1004.

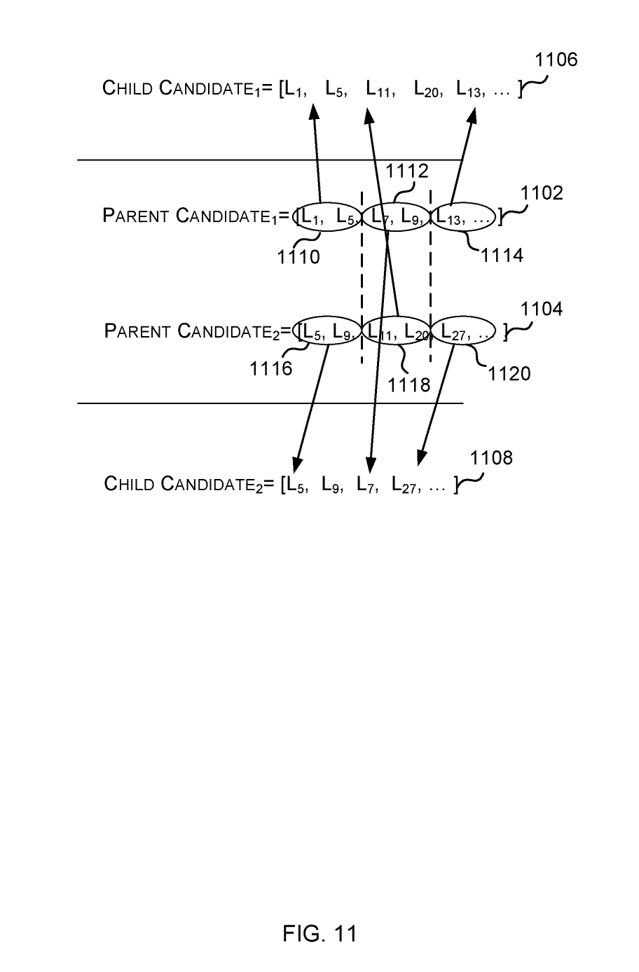

In some cases, one or more of the child candidate network topologies are generated from the parent candidate network topologies by mating or combining the parent candidate network topologies using a known technique such as, but not limited to crossover. Mating multiple parent candidate networks may comprise taking portions of each of the parent candidate network topologies and combining them to form a new child candidate network topology. An example of generating child candidate network topologies by mating parent candidate network topologies will be described with reference to FIG. 11.

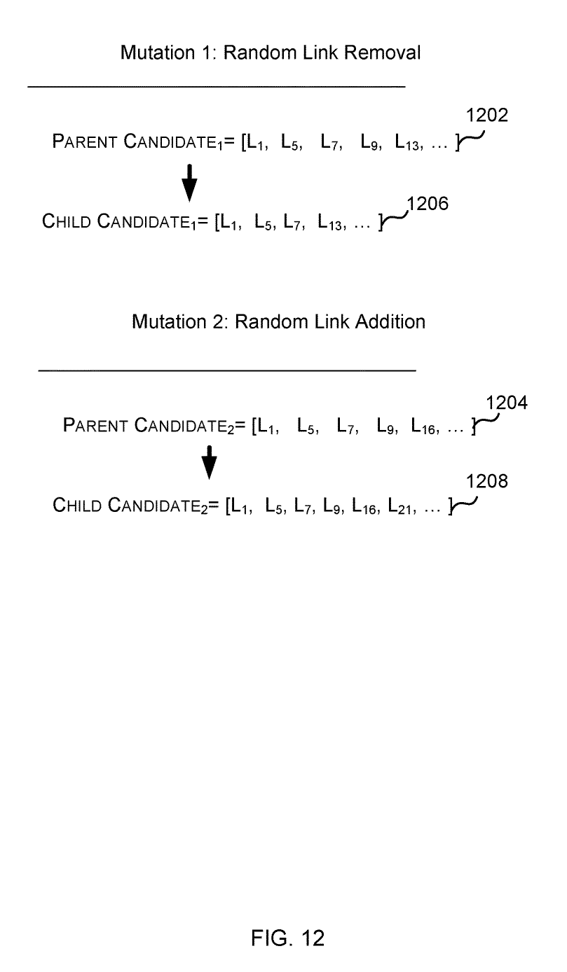

In other cases, one or more of the child candidate network topologies are generated by mutating the parent candidate network topologies. As is known to those of skill in the art, mutation involves altering a parent candidate network topology. In some cases this may comprise randomly removing elements (e.g. links) from the parent candidate network topology. In other cases this may comprise randomly adding elements (e.g. links) to the parent candidate network topology. An example of generating child candidate network topologies through mutation will be described with reference to FIG. 12.

In yet other cases, the child candidate network topologies may be generated through both mutation and mating. For example, parent candidate network topologies may be mated to produce one or more mated candidate network topologies, the mated candidate network topologies may then be mutated to form the child network topologies. Once the child candidate network topologies have been generated the method 1000 proceeds to block 1007.

At block 1008, capacity values are assigned to the links of the child network topologies generated at block 906 in accordance with the methods described above. Once the capacity values have been assigned the method 1000 proceeds to block 1008.

At block 1008, the child candidate network topologies generated at block 906 are evaluated by the candidate evaluation module 406. In some cases evaluation comprises determining a fitness value, as described above, for each child candidate network topology. Once the child candidate network topologies have been evaluated, the method 1000 proceeds to block 1010.

At block 1010, the child candidate network topologies are added to the set of candidate network topologies. For example, if the set of candidate network topologies obtained in block 902 comprised fifty candidate network topologies and two child candidate network topologies are generated then the updated set of candidate network topologies will comprise fifty-two candidate network topologies. Once the child candidate network topologies have been added to the set of candidate network topologies, the method 1000 proceeds to block 1012.

At block 1012, the candidate generation module 402 or the candidate evaluation module 406 removes X candidate network topologies from the combined set of candidate network topologies where X is the number of child candidate network topologies generated at block 1006. The X candidate network topologies may be selected on the basis of being the “worst” candidate network topologies or using other criteria, such a random selection criteria

Selecting and removing the “worst” candidate network topologies may comprise ranking the candidate network topologies in the combined set based on their associated fitness value and removing the X candidate network topologies with the worst (e.g. lowest) fitness values. For example, if the set of candidate network topologies obtained in block 1002 comprised fifty candidate network topologies, two child candidate network topologies are generated and added to the set, the two worst (e.g. based on fitness values) candidate network topologies are removed from the set to bring the total number of candidate network topologies in the set back to fifty.

If the X candidate network topologies are selected based on random selection, then X random candidate network topologies will be removed from the set. Optionally, the best C (where C is less than M) candidate network topologies may be guaranteed to survive (i.e. remain in the set) and the random selection may only be based on the remainder.

Regardless of the selection criteria, by adding X candidates and then removing X candidates the number of candidate network topologies in the set remains constant. Once X candidate network topologies have been removed from the set, the method 1000 ends.

Reference is now made to FIG. 11 which illustrates an example of generating child candidate network topologies by mating or combining parent candidate network topologies. In the example, two parent candidate network topologies 1102 and 1104 are selected from the set of candidate network topologies 404. As described above the parent candidate network topologies may be selected from the set of candidate network topologies based on on certain criteria (e.g. based on their fitness value) or they may be randomly selected from the set of candidate network topologies.

Two child candidate network topologies 1106 and 1108 are then generated by combining aspects (e.g. links) of the two parent candidate network topologies 1102 and 1104 so that the child candidate network topologies 1106 and 1108 comprise a combination of links from both parent candidate network topologies 1102 and 1104. In particular, in the example shown in FIG. 11 each of the two parent candidate network topologies 1102 and 1104 are divided into three parts 1110, 1112, 1114 and 1116, 1118, 1120. The first and third parts 1110 and 1114 of the first parent candidate network topology 1102 are combined with the second part 1118 of the second parent candidate network topology 1004 to form the first child candidate network topology 1106. Then the second part 1112 of the first parent candidate network topology 1102 is combined with the first and third parts 1116 and 1120 of the second parent candidate network topology 1104 to form the second child candidate network topology 1108. This technique is called crossover as different parts of a parent candidate network topology are sent to different child candidate network topologies.

It can be seen that any duplication of links in a child candidate network that result through this process may be removed so that a child candidate network topology does not contain a particular link more than once. For example, both the first part 1116 of the second parent candidate network topology 1104 and the second part 1112 of the first parent candidate network topology 1102 comprise link L₉, but link L₉ is only listed once in the second child candidate network topology 1108.

Although FIG. 11 illustrates generating child candidate network topologies by combining two parent candidate network topologies, it will be evident to a person of skill in the art that the method could be similarly applied to generate child candidate network topologies by combining more than two parent candidate network topologies. Similarly, although FIG. 11 illustrates a two-point crossover, it will be evident to a person of skill in the art that any number of crossover points may be used.

Reference is now made to FIG. 12 which illustrates examples of generating child candidate network topologies by mutating parent candidate network topologies. In the example shown in FIG. 12 two parent candidate network topologies 1202 and 1204 are selected from the set of candidate network topologies 404. As described above, the parent candidate network topologies may be selected from the set of candidate network topologies based on using certain criteria (e.g. based on their fitness value) or they may be randomly selected from the set of candidate network topologies 404.

Two child candidate network topologies 1206 and 1208 are then created from a mutation of one of the parent candidate network topologies 1202 and 1204. As described above, mutation comprises altering the parent candidate network topology in some manner. In the example shown in FIG. 12 the first child candidate network topology 1206 is created from the first parent candidate network topology 1202 through a mutation process that randomly removes one or more links from the parent candidate network topology 1202. For example, the first child candidate network topology 1206 is generated by removing the fourth link (L₉) from the first parent candidate network topology 1202. Other mutation methods may randomly remove more than one link and/or the number of links removed may be randomly selected.

In the example shown in FIG. 12, the second child candidate network topology 1208 is created from the second parent candidate network topology 1204 through a mutation process that randomly adds a link to the parent candidate network topology 1204. For example, the second child candidate network topology 1208 comprises all of the links of the second parent candidate network topology 1204 plus a new link (L₂₁). Other mutation methods may randomly add more than one link and/or the number of links added may be randomly selected.

In other cases links may be both added and removed. For example, mutating may comprise removing a link in the parent candidate network topology 1202 or 1204 to form a child candidate network topology and adding a link to the child candidate network topology that is not already in the child candidate network topology.

It will be evident to a person of skill in the art that FIG. 12 illustrates example mutation techniques and other known mutation techniques may also be used. For example, other mutation techniques may use heuristics to mutate a parent candidate network topology to generate one or more child candidate network topologies.

Reference is now made to FIG. 13 which illustrates an example stop condition which may be used by the stop condition module 412 to determine when to stop the iterative process (e.g. when a sufficiently optimum network topology has been identified). As described above, one stop condition that the stop condition module 412 may use is when the best fitness value for the set of candidate network topologies is sufficiently close to the predicted optimum fitness value. FIG. 13 show a graph 1300 of the best fitness value 1302 over time (e.g. as more iterations are performed).

It can be seen in FIG. 13 that as more iterations are performed the better the best fitness value becomes gradually approaching an asymptote 1304 that represents the optimum or best fitness value. There will be a point in the iterative process where the best fitness value will be within a certain percentage (e.g. 5%) 1306 of the optimum or best fitness value 1304. In some cases the stop condition module 412 is configured to determine a stop condition is satisfied if the best fitness values is within the predetermine percentage (e.g. 5%) 1306 of the optimum fitness value.

In some cases the stop condition module 412 is configured to, after each iteration (e.g. after each evolution step is completed), estimated the asymptote 1304 (e.g. the optimum or best fitness value) and compare the current best fitness value to the calculated asymptote 1304 to determine if the current best fitness value is within the predetermined percentage of the asymptote 1304. The estimation of the asymptote 1304 becomes more accurate over time (as more iterations are performed) as there is more data from which to calculate the asymptote 1304.

In some cases the best fitness value as a function of time/iterations 1302 is approximated as a rational function, R. As is known to those of skill in the art a rational function is the ratio of two polynomials. An example rational function, R, is illustrated in equation (4)

$$R = \frac{{A}_{0} + {A}_{1} * X + {A}_{2} * {X}^{2}}{1 + {B}_{1} * X + {B}_{2} * {X}^{2}} \qquad ( 4 )$$

Where the maximum exponent of the two polynomials is equal (e.g. in equation (4) the highest exponent for each of the polynomials is two) then the asymptote 1304 of the curve 1302 (the fitness at infinite iterations) is equal to the ratio of the coefficients of the maximum exponents. This is illustrated in equation (5).

$$Asymptote = \frac{{A}_{2}}{{B}_{2}} = Optimum Best Fitness \qquad ( 5 )$$

The two polynomial coefficients can be computed from a least squares method from the best fitness values after each iteration. Therefore, the more iterations, the more data (e.g. the more best fitness values) there is to estimate the curve and thus the more accurate the coefficients (and thus the more accurate the asymptote).

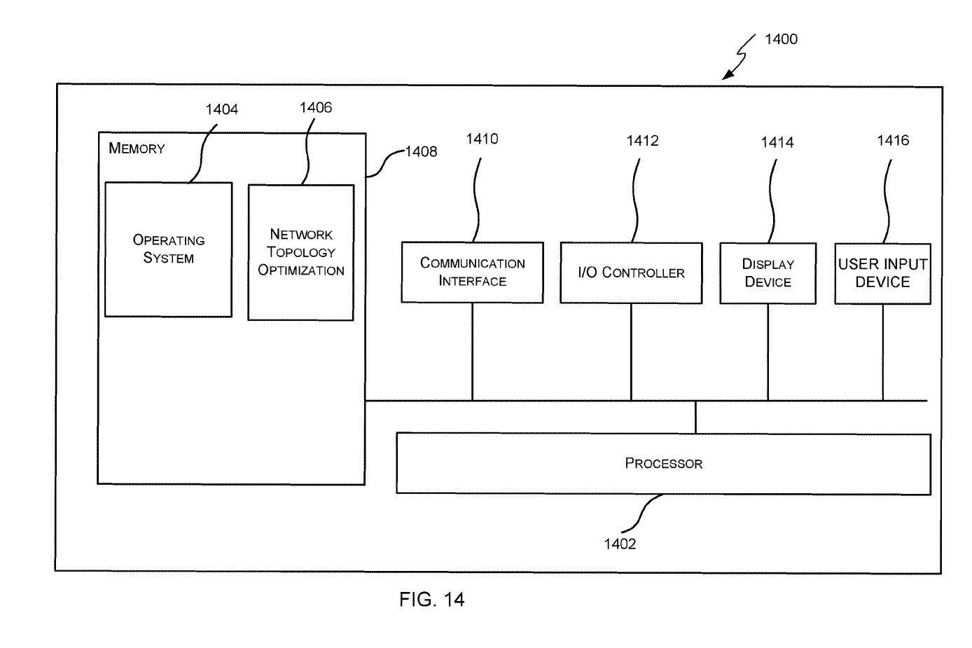

Reference is now made to FIG. 14 which illustrates various components of an exemplary computing-based device 1400 which may be implemented as any form of a computing and/or electronic device, and in which embodiments of the methods and systems described herein may be implemented.

Computing-based device 1400 comprises one or more processors 1402 which may be microprocessors, controllers or any other suitable type of processors for processing computer executable instructions to control the operation of the device in order to identify an optimum network topology for satisfying one or more service requirements under one or more constraints. In some examples, for example where a system on a chip architecture is used, the processors 1402 may include one or more fixed function blocks (also referred to as accelerators) which implement a part of the method of identifying an optimum network topology in hardware (rather than software or firmware). Platform software comprising an operating system 1404 or any other suitable platform software may be provided at the computing-based device to enable application software 1406, such as network topology optimization software to be executed on the computing based device 1400.

The computer executable instructions may be provided using any computer-readable media that is accessible by computing based device 1400. Computer-readable media may include, for example, computer storage media such as memory 1408 and communications media. Computer storage media (i.e. non-transitory machine readable media), such as memory 1408, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 1408) is shown within the computing-based device 1400 it will be appreciated that the storage may be distributed or located remotely and accessed via a network or other communication link (e.g. using communication interface 1410).

The computing-based device 1400 also comprises an input/output controller 1412 arranged to output display information to a display device 1414 which may be separate from or integral to the computing-based device 1400. The display information may provide a graphical user interface. The input/output controller 1412 is also arranged to receive and process input from one or more devices, such as a user input device 1416 (e.g. a mouse or a keyboard). In an embodiment the display device 1414 may also act as the user input device 1416 if it is a touch sensitive display device. The input/output controller 1412 may also output data to devices other than the display device, e.g. a locally connected printing device (not shown in FIG. 14).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1.-53. (canceled)

54. A system to determine a topology of a network for each of a plurality of demand scenarios, each demand scenario identifying a demand for each of a plurality of services to be run over the network, each demand indicating an amount of data to be transmitted from a start node to an end node, the system comprising:
one or more computer-based modules configured to:
(a) identify a demand scenario of the plurality of demand scenarios with the highest demands as a first demand scenario;
(b) identify, using an iterative process, a topology satisfying the first demand scenario, the iterative process comprising generating and evolving a set of candidate network topologies;
(c) identify the first demand scenario as a second demand scenario;
(d) identify a demand scenario of the plurality of demand scenarios with the next highest demands compared to the second demand scenario as the first demand scenario;
(e) identify a topology satisfying the first demand scenario using the iterative process, wherein the set of candidate network topologies for the first demand scenario comprises the identified network topology for the second demand scenario; and
(f) repeat (c) to (e) until a topology for each demand scenario has been identified and output the identified topology for each demand scenario.

55. The system of claim 54, wherein the one or more computer-implemented modules comprises:
a candidate generation module configured, for a particular demand scenario, to:
generate the set of candidate network topologies from a set of network resources; and
repeatedly evolve the set of candidate network topologies;
a candidate evaluation module configured to repeatedly evaluate each of the candidate network topologies based on the demand scenario and one or more constraints; and
a stop condition module configured to determine if one or more stop conditions is satisfied, and in response to determining at least stop condition is satisfied select the best candidate network topology from the set of candidate network topologies based on the evaluation of the candidate network topologies as the network topology and output the selected candidate network topology.

56. The system of claim 55, wherein evaluating a candidate network topology comprises generating a fitness value for that candidate network topology, the fitness value being a quantitative measure of a quality of that candidate network topology.

57. The system of claim 56, wherein generating a fitness value for a candidate network topology comprises generating a sub-fitness value for each constraint and combining the sub-fitness values to generate the fitness value, each sub-fitness value being a quantitative measure of how well that candidate network topology meets the constraint.

58. The system of claim 57, wherein each constraint is associated with a weight and the combination of the sub-fitness values is a weighted combination based on the associated weights.

59. The system of claim 56, wherein at least one stop condition is satisfied when at least one of the candidate network topologies in the set of candidate network topologies is within a predetermined percentage of an optimum network topology for the demand scenario based on the one or more constraints.

60. The system of claim 59, wherein determining whether at least one of the candidate network topologies in the set of candidate network topologies is within the predetermined percentage of the optimum network topology comprises determining if at least one of the fitness values is within the predetermined percentage of a predicted optimum fitness value.

61. The system of claim 56, wherein at least one stop condition is satisfied when the best fitness value has not changed after a predetermined number of evolutions.

62. The system of claim 56, wherein at least one stop condition is satisfied if the probability that the best fitness value is an optimum fitness value is above a predetermined threshold.

63. The system of claim 54, wherein evolving the set of candidate network topologies comprises generating at least one additional candidate network topology, adding the at least one additional candidate network topology to the set of candidate network topologies, and removing x of the candidate network topologies from the set of candidate network topologies, wherein x is the number of additional candidate network topologies generated.

64. A computer-implemented method to determine a topology of a network for each of a plurality of demand scenarios, each demand scenario identifying a demand for each of a plurality of services to be run over the network, each demand indicating an amount of data to be transmitted from a start node to an end node, the method comprising:
(a) identifying, using a computing-based device, a demand scenario of the plurality of demand scenarios having the highest demands as a first demand scenario;
(b) identifying, using an iterative process run on a computing-based device, a topology satisfying the first demand scenario, the iterative process comprising generating and evolving a set of candidate network topologies;
(c) identifying using the computing-based device, the first demand scenario as a second demand scenario;
(d) identifying, using the computing-based device, a demand scenario of the plurality of demand scenarios a next highest demands compared to the second demand scenario as the first demand scenario;
(e) identifying, using a computing-based device, a topology satisfying the first demand scenario using the iterative process, wherein the set of candidate network topologies for the first demand scenario comprises the identified network topology for the second demand scenario; and
(f) repeating (c) to (e) until a topology for each demand scenario has been identified and outputting the identified topology for each demand scenario.

65. The method of claim 64, where the iterative process comprises:
generating the set of candidate network topologies for a particular demand scenario, at a candidate generation module, from a set of network resources;
repeatedly evaluating, at a candidate evaluation module, each of the candidate network topologies based on the particular demand scenario and one or more constraints;
repeatedly determining, at a stop condition module, if one or more stop conditions are satisfied;
in response to determining none of the one or more stop conditions are satisfied, evolving the set of candidate network topologies; and
in response to determining at least one stop condition is satisfied, selecting the best candidate network topology from the set of candidate network topologies based on the evaluation of the candidate network topologies as the network topology for the particular demand scenario.

66. The method of claim 64, wherein evaluating a candidate network topology comprises generating a fitness value for that candidate network topology, the fitness value being a quantitative measure of a quality of that candidate network topology.

67. The method of claim 66, wherein generating a fitness value for a particular candidate network topology comprises generating a sub-fitness value for each constraint, and each sub-fitness value is a quantitative measure of how well the particular candidate network topology meets that constraint.

68. The method of claim 67, wherein each constraint is associated with a weight and the combination of the sub-fitness values is a weighted combination based on the associated weights.

69. The method of claim 66, wherein at least one stop condition is satisfied when at least one of the candidate network topologies in the set of candidate network topologies is within a predetermined percentage of an optimum network topology based on the at least one constraint and the demand scenario.

70. The method of claim 69, wherein determining whether at least one of the candidate network topologies in the set of candidate network topologies is within the predetermined percentage of the optimum network topology comprises determining if at least one of the fitness values is within the predetermined percentage of a predicted optimum fitness value.

71. The method of claim 66, wherein at least one stop condition is satisfied when the best fitness value has not changed after a predetermined number of evolutions performed by the candidate generation module.

72. The method of claim 66, wherein the stop condition is satisfied if the probability that the best fitness value is the optimum fitness value is above a predetermined threshold.

73. A computer readable storage medium having encoded thereon computer readable program code which when run by a computer causes the computer to perform the method of claim 64.
